(19) United States
(12) Patent Application Publication
(10) Pub. No.: US 2011/0189036 A1
(43) Pub. Date: Aug. 4, 2011

(54) Modular Vertical Pump Assembly

(75) Inventor: David S. Long, Houston, TX (US)

(73) Assignee: O'Drill/MCM Inc., Houston, TX (US)

(21) Appl. No.: 12/696,448

(22) Filed: Jan. 29, 2010

(51) Int. Cl. F04D 29/046; F04D 13/02; F04D 13/06; B23P 6/00

(52) U.S. Cl. 417/423.12; 417/321; 417/423.1; 29/888.021

(57) ABSTRACT

A modular vertical pump assembly has a motor, a coupling, a pump, a frame, and a base. The frame installs on the base around the pump, and supports of the frame hold a mount for the motor. The shaft from the motor extends through the mount, and the coupling installs between the motor shaft and a pump shaft. Preferably, the coupling uses an adapter and a stuffing box. Three supports fixedly attach to the mount and base, while one support is removable. To remove the pump for repair or replacement, the removable support detaches from the frame, and the pump detaches from the base and lifts from the frame's free side. Like the pump, the motor can be removed independently from the mount. In both cases, the coupling allows the pump's shaft to freely separate from the motor's shaft.

### BACKGROUND

FIG. 1 illustrates a vertical pump unit 10 according to the prior art. Examples of such vertical pump units 10 are manufactured by National Oilwell Varco/Mission and Forum. As shown, the unit 10 has an electric motor 20, a pump 30, and a stand 40. The electric motor 20 has a flange 22 that couples to the pump 30. In turn, the pump 30 has a flange 32 that couples to the stand 40. As is typical, the shaft of the electric motor directly couples to the pump. In particular, the pump 30 has an impeller 35 inside, and the motor shaft 24 close-couples directly to this internal impeller 35 so the electric motor 20 can operate the pump 30. When operated, fluid enters the pump's inlet 36, which can have an elbow 37 extending below the support 40. The internal impeller 35 turned by the motor shaft 24 moves the fluid to an outlet 38 on the side of the pump 30.

This vertical pump unit 10 commonly used in the art has several disadvantages. Primarily, the unit 10 has the close-coupled design between the motor 20 and pump 30, which has been used for many years. This close-coupling between the motor 20 and pump 30 requires the motor 20 to be custom made for the configuration and pump 30 used. As expected, such special requirements for the motor 20 can increase the cost of the unit 10 and complicate repairs.

The close-coupled design also requires the motor 20 to have an extended motor shaft 24 that operates as the actual pump shaft having the internal impeller 35 mounted thereon. A long extent of this motor shaft 24 may remain unsupported by bearings and seals, for example. In one particular pump unit, the extended motor shaft 24 can extend a length of about 22-inches that remains unsupported in the unit 10. Moreover, the extended motor shaft 24 acting as the pump shaft must run through required mechanical seals 34 for the pump 30. As expected, the intricacies of the extended shaft 24 and required mechanical seals 34 can lead to early failures of the unit 10. In addition, the front bearings in the motor 20 carry the full load of the pump's impeller 35 during operation. When the unit 10 is pumping heavy mud or other fluid, the motor's bearings can experience a very heavy load that can also cause premature failure.

Finally, when the pump 30, the motor 20, or both fail, the entire unit 10 must be removed from a site for any maintenance or repairs to be performed. To do this, operators must remove all discharge and suction piping from the inlet 37 and outlet 38. Then, due to the weight of the unit 10, capable equipment such as a crane must be used to remove the entire unit 10 from the site. As expected, this procedure can be very costly and time-consuming. The actual repairs of the unit 10 will also be expensive because the close-coupled motor 20 and pump 30 must be disassembled from one another.

The subject matter of the present disclosure is directed to overcoming, or at least reducing the effects of, one or more of the problems set forth above.

### SUMMARY

A modular vertical pump assembly has a motor, a coupling, a pump, a frame, and a base. The base installs at an installation and has an opening in a top through which a tee or elbow flange installs from the pump's inlet. The pump installs on this base, and the frame installs on the base around the pump. The frame has a mount held by several supports, and the motor attaches to the mount above the pump. To connect the motor to the pump, the motor's shaft extends through the mount, and the coupling installs between the motor shaft and a pump shaft. Preferably, the coupling uses an adapter and a stuffing box.

Three of the frame's supports fixedly attach between the mount and the base, while one of the supports is removable. To remove the pump for repair or replacement, the removable support detaches from the frame, and the pump detaches from the base and lifts from the frame's free side. Like the pump, the motor can be removed independently from the unit by detaching the motor from the top mount. In both cases, the coupling allows the pump's shaft to freely separate from the motor's shaft.

The foregoing summary is not intended to summarize each potential embodiment or every aspect of the present disclosure.

### BRIEF DESCRIPTION OF THE DRAWINGS

FIG. 1 illustrates a vertical pump unit according to the prior art.

FIG. 2 schematically shows a drilling implementation having a modular vertical pump assembly according to the present disclosure.

FIG. 3A is a first side view of a modular vertical pump assembly according to the present disclosure.

FIG. 3B is a second side view of the modular vertical pump assembly.

FIG. 3C is a top view of the assembly's upper platform.

FIG. 4 shows the modular vertical pump assembly with the motor being replaced.

FIG. 5 shows the modular vertical pump assembly with the pump being replaced.

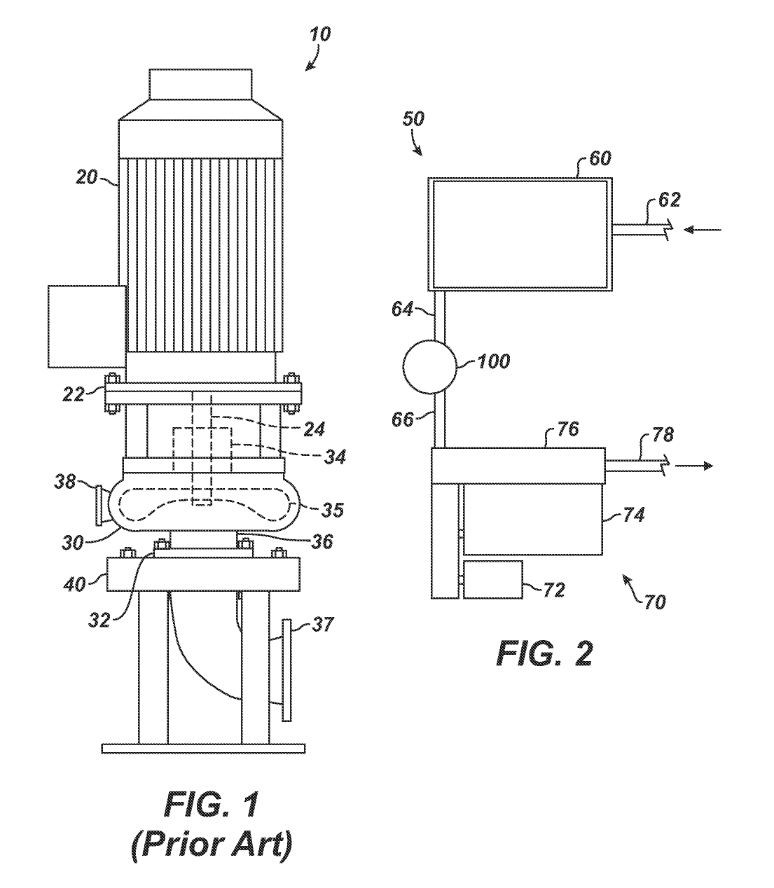

### DETAILED DESCRIPTION

FIG. 2 schematically shows an exemplary implementation having a modular vertical pump assembly 100 according to the present disclosure. This implementation is a mud drilling application having a mud tank 60 and a mud pump 70. Although discussed in terms of a drilling mud application, the modular assembly 100 can be used in any pumping application that requires a high-volume, low-pressure water, slurries, drilling mud, or other fluid to be pumped. Therefore, the modular assembly 100 can be used in the oil field, mining, municipal water, wastewater, and agricultural industries, for example.

In the drilling application, drilling mud from a wellhead (not shown) enters the mud tank 60 through piping 62. The modular assembly 100 situates between the mud tank 60 and the mud pump 70 and charges the mud pump 70 with drilling mud by pumping drilling mud via suction line 64 from the tank 60 to the mud pump's manifold 76 via discharge line 66. The mud pump's motor 72 then operates a piston assembly 74 in the pump 70 to move the drilling mud from the manifold 76 to the wellhead (not shown) via piping 78.

As can be seen in such an implementation, the modular vertical pump 100 needs to operate in an environment where a high-volume of heavy fluid is pumped. Additionally, access to the modular assembly 100 for repairs and maintenance may be restricted due to the piping and other components of the installation nearby. Yet, as discussed in more detail below, the modular assembly 100 of the present disclosure overcomes the disadvantages of the common close coupled vertical pump units used in the art.

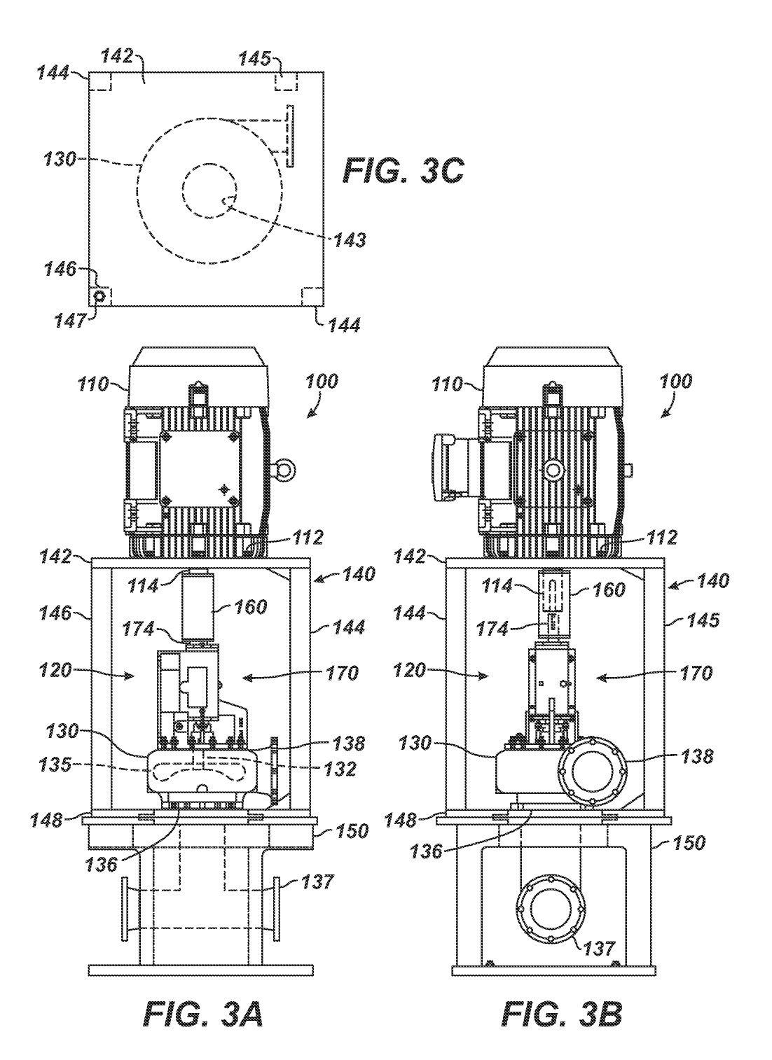

Turning to particulars, the modular vertical pump assembly 100 according to the present disclosure is illustrated in FIGS. 3A-3C. This modular assembly 100 can install at an installation where a conventional close-coupled vertical pump unit can be used, and the assembly 100 can directly fit as a replacement for such a conventional unit. As shown, the assembly 100 is a free-standing unit that reduces the footprint required in an installation. Compared to the direct coupled design in the prior art, the modular assembly 100 also greatly reduces installation and maintenance time in the field. For installation, the complete assembly 100 can be installed as a unit at a site, but the individual components of the motor 110, pump 130, and coupling 120 can be accessed and removed individually. In this way, operators do no need to remove the complete assembly 100 for any maintenance.

As shown in FIGS. 3A-3B, the modular assembly 100 has a motor 110, a coupling 120, a pump 130, a frame 140, and a base 150. The base 150 installs at the installation and has an opening in a top through which a tee or elbow 137 installs from the pump's inlet 136. For its part, the pump 130 installs on the base 150 and has a pump shaft 132 that extends from a top of the pump 130. Inside, the pump shaft 132 couples to an internal impeller 135 in the pump 130. Fluid from suction piping (not shown) enters the pump's inlet 136 via the tee or elbow 137. As the pump 130 operates, the impeller 135 increases the pressure of the fluid, and the pump 130 discharges the fluid through a side outlet 138, which is connected to discharge piping (not shown). Being independent in the assembly 100, the pump 130 can have a short frame pump design with an independent pump shaft 132 with the internal impeller 135 mounted directly thereon. In this way, the pump's shaft 132 is more fully supported with heavy duty bearings inside the pump 130, and the shaft 132 can have only a short extent that would remain unsupported. This allows the pump's mechanical seals to last much longer.

The frame 140 installs on the base 150 around the pump 130 and has a plurality of support legs 144/146 extending between mounts or platforms 142/148. Three of the support legs 144 are fixedly attached between the platforms 142/148. However, one of the support legs 146 is removable. As shown in the top view of the upper platform 142 in FIG. 3C, for example, the top end of this removable leg 146 can affix to the platform 142 by a bolt 147 or the like. (Although not shown, the bottom end of this leg 146 may or may not affix to the bottom platform 148.) As also shown in FIG. 3C, one corner leg 144 is offset slightly to allow piping (not shown) to attach to the flange of the pump's outlet 138.

The motor 110 installs on the frame's top platform 142 and can be held by bolts 112 or the like. A motor shaft 114 extends through a central opening (143; FIG. 3C) in the frame's top platform 142, and the coupling 120 installs between the motor shaft 114 and the pump shaft 132 to couple them together. In this way, the motor 110 is fully supported independently on the modular frame 140 so the motor 110 will not experience extra weight or loads during operation.

The coupling 120 between the motor 110 and the pump 130 can isolate any the motor 110 from the pump 130 so any pump malfunctions can be kept from damaging the motor 110. Preferably, the coupling 120 provides one or more degrees of freedom between the coupled motor 110 and pump 130. In the present implementation, the coupling 120 includes a coupling adapter 160 and a bearing housing/stuffing box arrangement 170 with an exposed shaft end 174. The coupling adapter 160 couples the motor shaft 114 with the exposed shaft end 174. A suitable example of for the coupling adapter 160 is a Sure-Flex® type coupling available from TB Wood's, Incorporated, although other types of couplings can be used.

The bearing housing/stuffing box arrangement 170 transfers the rotation of the shaft end 174 by the motor 110 to rotation of the pump shaft 132 having the impeller 135. In addition, the arrangement 170 includes mechanical seals, gaskets, bearings, washers, etc. for supporting and isolating this transfer of motion. Suitable examples for the pump 130 with stuffing box and bearing housing arrangement 170 include the centrifugal or vortex pumps available from O'Drill MCM, such as its 250 pump series.

Because the motor shaft 114 does not act as a pump shaft, the pump 130 and motor 110 can experience less wear and last longer than a close-coupled design. Moreover, the motor 110 can be a standard C-face motor, for example, so that the assembly 100 does not require a specific motor design. Having a C-face design, a flange on the motor's face supports the motor 130 for mounting directly to the top platform 142 with bolts 112. Moreover, the C-face design of the motor 130 provides a much stronger shaft and bearing arrangement, which can lead to a much longer mechanical seal life than conventionally experienced with vertical close-coupled pumps.

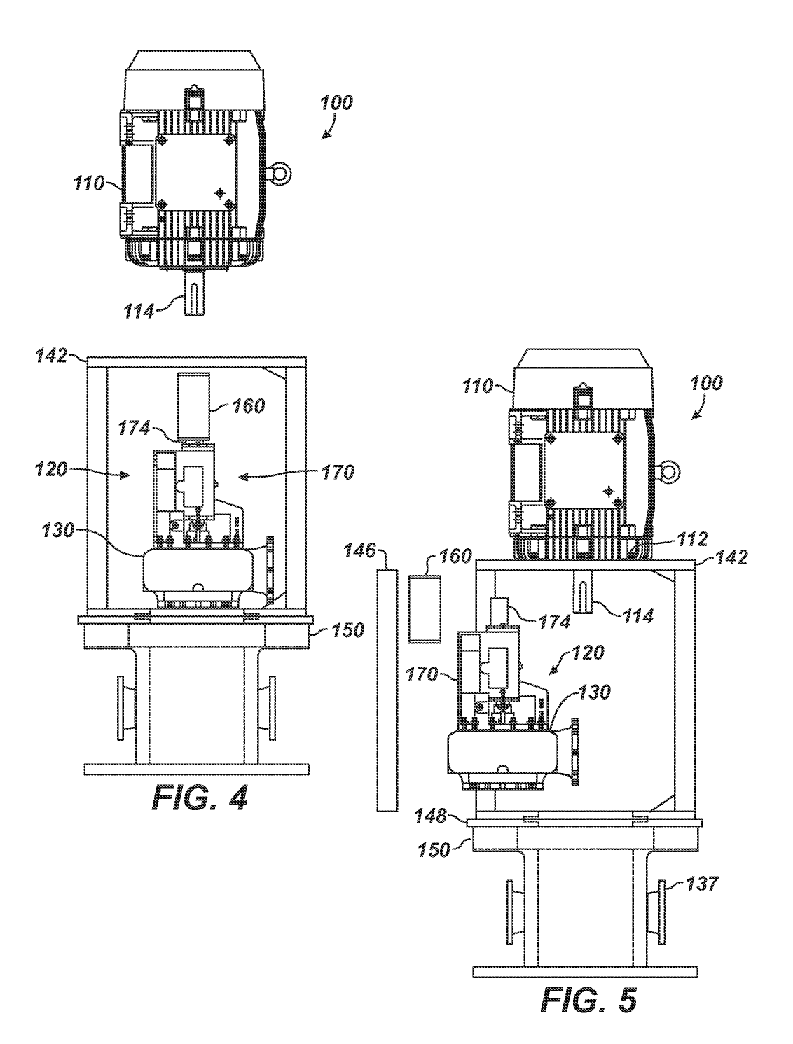

As evident above, the motor 110 can be removed individually from the modular assembly 100 for any maintenance or repair. As shown in FIG. 4, for example, the motor 110 removes from the top platform 142 by removing the bolts (112) affixing the motor 110 thereto. The motor 110 can then be lifted from the frame 140 with the motor shaft 114 separating from the coupling adapter 160. A replacement motor 110 can then be installed on the frame 140 in the removed motor's place. To move the motor 110 in this way, operators can use conventionally devices available at an installation and do not need to have a specific crane capable of lifting the entire assembly 100.

As also evident above, the modular frame 140 has fixed support legs 144 and at least one removable leg 146 between the upper and lower platforms 142/148. The removable leg 146 allows the pump 130 to be removed from the assembly 100 for any required maintenance or repair. As shown in FIG. 5, for example, the leg 148 can be removed from the frame 140 by unbolting it from one or both of the platforms 142/148. This provides operators with access to the pump 130. Operators can then detach the pump 130 from the base 150 and/or bottom platform 148 to lift the pump 130 from the frame 140 through the open side. When removing the pump 130, operators separate the exposed end of the pump shaft 132 from the coupling adapter 160. A replacement or serviced pump 130 can then be installed back into the assembly 100, and the removable leg 146 can be reattached between the platforms 142/148.

As FIGS. 4-5 show, either one or both of the pump 130 and motor 110 can be removed from the assembly 100 if needed. Therefore, operators can leave all piping in place at the site and do not need to lift the entire assembly 100 from its location. This simplifies repairs and installation. Once installed, the modular frame 140 does not need to be removed again if the motor 110 or pump 130 requires any repairs or maintenance. Only the motor 110 and pump 130 need to be removed. Moreover, removal of just the pump 130 or motor 110 can be accomplished using standard equipment found on the drilling rigs or the like. In this way, operators do not need to rent a crane or other cumbersome equipment.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A modular vertical pump assembly, comprising:
a base disposed at an installation;
a pump disposed on the base, the pump having an inlet and an outlet and having a pump shaft extending from the pump;
a frame disposed on the base, the frame having a plurality of supports and a mount, the supports supporting the mount above the base and the pump, at least one of the supports being removable from between the base and the mount;
a motor disposed on the mount and having a motor shaft extending to the pump shaft; and
a coupling disposed between the motor shaft and the pump shaft,
wherein the at least one support is removable from the frame and the pump is removable from the assembly independently of the motor, and
wherein the motor is removable from the assembly independently of the pump.

2. The assembly of claim 1, wherein the pump comprises a centrifugal pump having an impeller disposed on the pump shaft inside the pump.

3. The assembly of claim 1, wherein the motor comprises an electric motor having a flange affixing to the mount.

4. The assembly of claim 1, wherein the coupling comprises a stuffing box and bearing housing coupled between the pump shaft and the motor shaft.

5. The assembly of claim 4, wherein the coupling comprises an adapter coupling the motor shaft to an end of the pump shaft extending from the stuffing box and bearing housing.

6. The assembly of claim 1, wherein the coupling provides one or more degrees of freedom between the motor shaft and the pump shaft.

7. The assembly of claim 1, wherein one end of the at least one leg removably affixes to the mount by a fastener.

8. The assembly of claim 1, wherein the assembly having the base, the frame, the pump, and the motor are movable as a unit.

9. A modular vertical pump assembly, comprising:
a base disposed at an installation and having an opening in a top thereof;
a pump disposed on the base and having a pump shaft extending from a top thereof, the pump having an inlet in a bottom and having an outlet in a side, the inlet communicating with the opening in the base;
a frame disposed on the base, the frame having a plurality of supports and a mount, the supports supporting the mount above the base and the pump, at least one of the supports being removable from between the base and the mount;
a motor disposed on the mount and having a motor shaft extending through an opening in the mount; and
a stuffing box and bearing housing supporting the pump shaft from the pump; and
an adapter coupling an exposed end of the pump shaft to the motor shaft,
wherein the at least one support is removable from the frame and the pump is removable from the assembly independently of the motor, and
wherein the motor is removable from the assembly independently of the pump.

10. The assembly of claim 9, wherein the pump comprises a centrifugal pump having an impeller disposed on the pump shaft inside the pump.

11. The assembly of claim 9, wherein the motor comprises an electric motor having a flange affixing to the mount.

12. The assembly of claim 9, wherein the adapter provides one or more degrees of freedom between the motor shaft and the pump shaft.

13. The assembly of claim 9, wherein one end of the at least one support removably affixes to the mount by a fastener.

14. A pump service method, comprising:
installing a modular vertical pump assembly at a site, the assembly having:
a base,
a pump supported on the base,
a frame supported on the base and having a plurality of legs and a platform, the legs extending from the base and supporting the platform,
a motor supported on the platform, and
a coupling between a pump shaft and a motor shaft;
wherein the pump is separately removable from the assembly independent of the motor by:
removing at least one of the legs from the frame,
detaching the pump from the base,
uncoupling the pump shaft from the coupling with the motor shaft, and
removing the pump from the frame where the at least one leg has been removed.

15. The method of claim 14, wherein the motor is separately removable from the assembly independent of the pump by:
detaching the motor from the platform; and
uncoupling the motor shaft from the coupling with the pump shaft.

16. The method of claim 15, wherein piping coupled to the assembly remains connected thereto when separately removing the motor from the assembly.

17. The method of claim 14, wherein separately removing the pump from the assembly comprises detaching piping from an outlet of the pump.
